(19) United States
(12) Patent Application Publication
(10) Pub. No.: US 2026/0274347 A1
(43) Pub. Date: Sep. 17, 2026

(54) AUTOMOBILE ACCESSORY ADVERTISING DEVICE

(71) Applicant: Edward Gerard Shelley, Sherwood Park (CA)

(72) Inventor: Edward Gerard Shelley, Sherwood Park (CA)

(21) Appl. No.: 19/078,579

(22) Filed: Mar. 13, 2025

(51) Int. Cl. B62D 25/18; B60Q 1/50

(52) U.S. Cl. CPC B62D 25/18; B60Q 1/5035

(57) ABSTRACT

An advertising device that is configured to be operably coupled to a vehicle adjacent a tire of the vehicle wherein the present invention provides promotion of a desired entity. The device includes a support member wherein the support member is planar in form being manufactured from a rigid material. The support member includes a first side and a second side wherein the first side is adjacent to and facing the tire of the vehicle. The second side of the support member has a display member secured thereto. The display member is planar in manner being manufactured from a rigid material. The outer surface of the display member has indicia imprinted thereon for promotion of a desired entity. The display member can be equally sized to the support member or be sized so as to have a surface area less than that of the second side of the support member.

### FIELD OF THE INVENTION

The present invention relates generally to advertising paraphernalia, more specifically but not by way of limitation, a debris deflection device that is mounted to a vehicle adjacent a tire on the vehicle wherein the present invention includes a support member having a display member secured to the outer surface thereof.

### BACKGROUND

In the dynamic realm of modern advertising, strategies have evolved to reach consumers in increasingly innovative ways. Among these strategies, advertising on automobiles stands out as a unique and effective approach. This method, which leverages the mobility and visibility of vehicles, offers businesses an opportunity to communicate their brand messages to a diverse and expansive audience. Advertising on automobiles encompasses a range of tactics, including vehicle wraps, decals, magnetic signs, and digital displays. These methods transform vehicles into mobile billboards, providing businesses with an unconventional yet impactful advertising platform. The appeal of automobile advertising lies in its ability to transcend the limitations of stationary advertisements. Unlike traditional billboards or posters, which are confined to specific locations, vehicles traverse urban and suburban landscapes, exposing advertisements to a constantly changing audience. One of the most significant advantages of automobile advertising is its cost-effectiveness. Compared to television or radio commercials, vehicle-based advertisements often require a lower initial investment while maintaining long-term visibility. A single wrapped vehicle, for instance, can generate thousands of impressions daily as it moves through high-traffic areas. This capability makes automobile advertising particularly attractive to small and medium-sized enterprises (SMEs) that may lack the budget for large-scale campaigns.

Additionally, automobile advertising offers unparalleled flexibility and customization. Businesses can tailor their designs to align with specific marketing goals or demographics. For example, a company targeting younger consumers might employ vibrant, eye-catching graphics, while a brand catering to professionals might opt for sleek, minimalist designs. This adaptability ensures that advertising messages resonate with their intended audiences, maximizing the campaign's effectiveness. Moreover, automobile advertising can contribute to a brand's credibility and professionalism. A well-designed vehicle wrap not only attracts attention but also conveys a sense of legitimacy and permanence. Customers are more likely to trust a business that invests in such visible and creative marketing methods, fostering stronger brand recognition and loyalty. However, automobile advertising is not without its challenges. Regulatory restrictions and local ordinances may limit the extent or type of advertisements allowed on vehicles. Furthermore, poorly designed or excessively flashy ads can alienate potential customers or fail to deliver the intended message. To mitigate these risks, businesses must prioritize high-quality designs and ensure compliance with legal requirements. Advertising on automobiles represents a compelling fusion of mobility, creativity, and cost efficiency. While methods have proven effective, additional opportunities exist in this field.

Accordingly, there is a need for an advertising device operably coupled to an automobile, wherein the device provides a functional vehicular purpose as well as provide advertising on the outer surface thereof.

### SUMMARY OF THE INVENTION

It is the object of the present invention to provide an advertising device configured to be operably coupled to a vehicle adjacent a tire wherein the present invention includes a support member that is planar in form being manufactured from a rigid material.

Another object of the present invention is to provide a vehicular advertising device that is positioned adjacent a tire of a vehicle wherein the support member includes a first surface and a second surface.

A further object of the present invention is to provide an advertising device configured to be operably coupled to a vehicle adjacent a tire wherein the first surface of the support member is oriented towards a tire of the vehicle.

Yet a further object of the present invention is to provide a vehicular advertising device that is positioned adjacent a tire of a vehicle wherein the second surface of the support member faces away from the tire of the vehicle.

Still another object of the present invention is to provide an advertising device configured to be operably coupled to a vehicle adjacent a tire wherein the present invention includes a display member operably coupled to the support member.

An additional object of the present invention is to provide a vehicular advertising device that is positioned adjacent a tire of a vehicle wherein the display member is planar in form and secured to the second surface of the support member.

Yet a further object of the present invention is to provide an advertising device configured to be operably coupled to a vehicle adjacent a tire wherein the display member includes indicia imprinted on the outer surface thereof.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of an embodiment of the present invention.

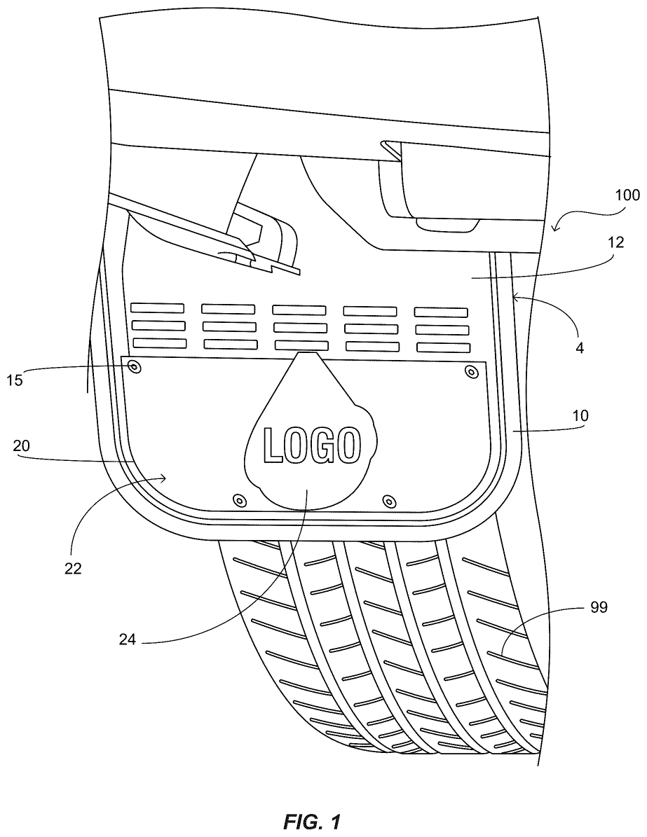

### DETAILED DESCRIPTION

Referring now to the drawings submitted herewith, wherein various elements depicted therein are not necessarily drawn to scale and wherein through the views and figures like elements are referenced with identical reference numerals, there is illustrated an advertising device 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the advertising device 100 includes a support member 10. The support member 10 is planar in manner being manufactured from a rigid material such as but not limited to plastic or rubber. The support member 10 is secured to a vehicle adjacent to and rearward of a tire 99 utilizing suitable durable techniques. The support member 10 includes a first surface 11 wherein the first surface 11 is oriented towards the tire 99. It should be understood within the scope of the present invention that the support member 10 could be provided in alternate sizes and shapes. The support member 10 functions to provide blockage of debris and mud inhibiting the distribution thereof onto the vehicle or rearward of the vehicle onto a trailer being towed or an adjacent vehicle. The support member 10 includes second surface 12 which is oriented such that the second surface 12 faces away from the tire 99.

A display member 20 is secured to the second surface 12 of the support member 10. Display member 20 is secured utilizing fasteners 15. It is contemplated within the scope of the present invention that the display member 20 could be secured utilizing numerous types of suitable fasteners such as but not limited to screws or bolts. The display member 20 is planar in manner being manufactured from a rigid material such as but not limited to metal. It is contemplated within the scope of the present invention that the display member 20 could be sized either equally to the support member 10 or have a size that is less than that of the second surface 12. The display member 20 includes an outer surface 22 wherein the outer surface 22 has indicia 24 imprinted thereon. The indicia 24 is utilized to advertise a desired item such as but not limited to a sports team or business. The indicia 24 can be imprinted on the outer surface 22 of the display member 20 utilizing numerous suitable techniques. While a preferred embodiment of the present invention has indicia 24 on the display member 20, it is further contemplated within the scope of the present invention that the display member 20 could be an electronic display remotely controlled via an interface such as but not limited to a smart phone. The display member 20 could be comprised of a flexible LED panel or similar device in this contemplated embodiment.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An advertising device configured to be operably coupled to a vehicle wherein the advertising device comprises:
a support member, said support member being planar in manner, said support member having a first side and a second side, said support member operably coupled to a vehicle adjacent a tire thereof, said first side of said support member facing the tire, said support member being vertically oriented;
a display member, said display member being secured to said second side of said support member, said display member being planar in manner, said display member having an outer surface, said display member covering at least a portion of a surface area of the second side of said support member; and
wherein indicia is imprinted on the outer surface of said display member.

2. The advertising device configured to be operably coupled to a vehicle as recited in claim 1, wherein the support member is manufactured from rubber or plastic.

3. The advertising device configured to be operably coupled to a vehicle as recited in claim 2, wherein the display member is secured to the support member employing a plurality of fasteners.

4. The advertising device configured to be operably coupled to a vehicle as recited in claim 3, wherein the display member is manufactured from metal.
